(19) United States
(12) Patent Application Publication
(10) Pub. No.: US 2023/0188763 A1
(43) Pub. Date: Jun. 15, 2023

(54) METHODS FOR PROCESSING LIVE PREVIEW, ELECTRONIC DEVICE, AND STORAGE MEDIUM

(71) Applicant: BEIJING DAJIA INTERNET INFORMATION TECHNOLO CO., LTD., Beijing (CN)

(72) Inventor: Ying WANG, Beijing (CN)

(21) Appl. No.: 17/902,501

(22) Filed: Sep. 2, 2022

(30) Foreign Application Priority Data
Dec. 9, 2021 (CN) 202111498063.0

(51) Int. Cl. H04N 21/2187; G06Q 10/02

(52) U.S. Cl. CPC H04N 21/2187; G06Q 10/02

(57) ABSTRACT

The present disclosure relates to methods and apparatuses for processing a live preview, an electronic device and a storage medium. The method includes obtaining, in response to a predetermined event for a target live preview, reservation information for the target live preview; and sending, in response to the reservation information meeting a predetermined condition, target processing information for the target live preview to a target object based on the predetermined event.

### CROSS-REFERENCE TO RELATED APPLICATION

The present disclosure is based on and claims priority under 35 U.S.C. 119 to Chinese Patent Application No. 202111498063.0, filed on Dec. 9, 2021, in the China National Intellectual Property Administration, the entire contents of which are incorporated herein by reference.

### TECHNICAL FIELD

The present disclosure relates to the field of live streaming technology, and in particular, to methods and apparatuses for processing a live preview, an electronic device, and a storage medium.

### BACKGROUND

With the rapid development of live streaming technology, more and more users are joining the live streaming industry, through which the recommendation of objects such as merchandise can be made.

In the related art, a live preview may often be released in advance before the live streaming starts, which realizes the early warm-up of the live streaming room, and can attract more users to the live streaming room of the anchor. However, with the widespread use of live preview, there are also cases of abuse of live previews, which leads to poor user experience and also causes the waste of system resources. Therefore, how to effectively monitor and handle the abnormal situation of live previews has become an urgent problem to be solved.

### SUMMARY

The present disclosure provides methods and apparatuses for processing a live preview, an electronic device, and a storage medium. The technical solutions of the present disclosure are as follows.

According to a first aspect of embodiments of the present disclosure, there is provided a method for processing a live preview applied to a server. The method includes: obtaining, in response to a predetermined event for a target live preview, reservation information for the target live preview, the predetermined event including an event that cause the target live preview to be invalid; and sending, in response to the reservation information meeting a predetermined condition, target processing information for the target live preview to a target object based on the predetermined event, the target object including a creator of the target live preview, the target processing information being configured at least for prompting a restriction on the use of the target live preview by the target obj ect.

According to a second aspect of embodiments of the present disclosure, there is provided a method for processing a live preview applied to a terminal corresponding to a target object that includes a creator of a target live preview. The method includes: receiving target processing information for the live preview that is sent by a server for the target live preview based on a predetermined event, where the predetermined event includes an event that causes the target live preview to be invalid, and the target processing information is sent in response to reservation information of the target live preview meeting a predetermined condition and is configured at least for prompting a restriction on the use of the target live preview by the target object; and displaying the target processing information.

According to a third aspect of embodiments of the present disclosure, there is provided an electronic device, including a processor and a memory storing instructions executable by the processor. The processor is configured to execute instructions to implement the method as described in the first aspect or second aspect.

According to a fourth aspect of embodiments of the present disclosure, there is provided a non-transitory computer-readable storage medium, in response to instructions in the storage medium executed by a processor of an electronic device, causing the electronic device to perform the method as described in the first aspect or second aspect of the present disclosure.

According to a fifth aspect of embodiments of the present disclosure, there is provided a computer program product including instructions that, when run on a computer, cause the computer to perform the method described in any one of the embodiments of above first aspect or second aspect of the present disclosure.

It should be understood that the foregoing general description and the following detailed descriptions are exemplary and explanatory only and do not limit the present disclosure.

### BRIEF DESCRIPTION OF THE DRAWINGS

The accompanying drawings herein, incorporated into and form part of the specification, illustrate embodiments consistent with the present disclosure, and are used to explain the principles of the present disclosure in conjunction with the specification and do not constitute an undue limitation of the present disclosure.

FIG. 1 is a schematic diagram of an application environment illustrated according to an exemplary embodiment.

FIG. 2 is a flowchart of a method for processing a live preview illustrated according to an exemplary embodiment.

FIG. 3 is a flowchart of another method for processing a live preview illustrated according to an exemplary embodiment.

FIG. 4 is a schematic diagram of a preview creation page provided according to an exemplary embodiment.

FIG. 5 is a schematic diagram of a first prompt message provided according to an exemplary embodiment.

FIG. 6 is a schematic diagram of a second prompt message provided according to an exemplary embodiment.

FIG. 7 is a schematic diagram of a third prompt message provided according to an exemplary embodiment.

FIG. 8 is a block diagram of an apparatus for processing a live preview illustrated according to an exemplary embodiment.

FIG. 9 is a block diagram of an apparatus for processing a live preview illustrated according to an exemplary embodiment.

FIG. 10 is a block diagram of an electronic device for processing a live preview illustrated according to an exemplary embodiment.

FIG. 11 is a block diagram of an electronic device for processing a live preview illustrated according to an exemplary embodiment.

### DETAILED DESCRIPTION

In order to allow those of ordinary skills in the art to better understand the technical solutions of the present disclosure, the technical solutions in the embodiments of the present disclosure will be clearly and completely described below with reference to the accompanying drawings.

It should be noted that the terms “first,” “second,” etc. in the specification and claims of the present disclosure and the accompanying drawings above are used to distinguish similar objects and not necessarily used to describe a particular order or sequence. It should be understood that the term so used may be interchanged, where appropriate, so that embodiments of the present disclosure described herein can be implemented in an order other than those illustrated or described herein. The embodiments described in the following examples are not intended to represent all embodiments consistent with the present disclosure. Rather, they are only examples of devices and methods that are consistent with some aspects of the present disclosure, as detailed in the appended claims.

It should be noted that the user information (including but not limited to user device information, user personal information, etc.) and data (including but not limited to data for display, data for analysis, etc.) involved in this disclosure are information and data authorized by the user or fully authorized by the parties.

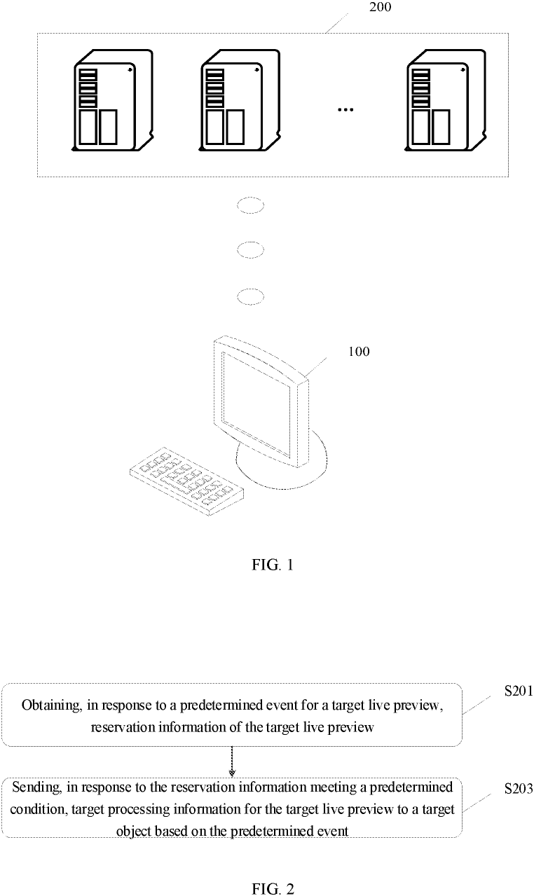

Referring to FIG. 1, FIG. 1 is a schematic diagram of an application environment illustrated according to an exemplary embodiment. As shown in FIG. 1, the application environment may include the terminal 100 and the server 200.

In an optional embodiment, the terminal 100 can be used to provide live streaming services to any user. Specifically, the terminal 100 may include, but is not limited to, smartphones, desktop computers, tablets, laptops, smart speakers, digital assistants, augmented reality (AR)/virtual reality (VR) devices, smart wearable devices, and other types of electronic devices, and may also be software, such as applications, running on the aforementioned electronic devices. Optionally, the operating system running on the electronic device may include, but is not limited to, Android, IOS, Linux, windows, etc.

In an optional embodiment, the server 200 may provide background support for the live streaming server of the terminal 100. Specifically, server 200 may be a standalone physical server, a server cluster or distributed system composed of multiple physical servers, or a cloud server that provides cloud services, cloud database, cloud computing, cloud functions, cloud storage, network services, cloud communications, middleware services, domain name services, security services, Content Delivery Network (CDN), and big data and artificial intelligence platforms, and other basic cloud computing services.

In addition, it should be noted that FIG. 1 shows only one application environment provided by the present disclosure, and in practical applications other application environments may also be included, for example, more terminals may be included.

In the embodiments of this specification, the terminal 100 as well as the server 200 may be communicated by wired or wireless directly or indirectly, which is not limited by this disclosure herein.

FIG. 2 is a flowchart of a method for processing a live preview illustrated according to an exemplary embodiment. As shown in FIG. 2, the method for processing the live preview is applied to a server, which includes the following steps S201 and S203.

In step S201, in response to a predetermined event for a target live preview, reservation information of the target live preview is obtained.

In a particular embodiment, the target live preview may be a multimedia resource for introducing the live content of a particular live streaming in advance. Optionally, the multimedia resource may include, but is not limited to, media resources such as graphics, short videos, etc. Specifically, the predetermined event for the target live preview may be an event that causes the target live preview to be invalid, e.g., a deletion preparation event, a deletion confirmation event, or an expired unbroadcast event. Specifically, the reservation information of the target live preview may be information that reflects a reservation to watch a live streaming corresponding to the target live preview, e.g., the number of viewers who have reserved to watch the live streaming corresponding to the target live preview. Optionally, the reservation information for the target live preview can be obtained by calling a reservation service. Specifically, the reservation service may be a remote call service for managing the live previews.

In an optional embodiment, the predetermined event may include the expired unbroadcast event of a live streaming corresponding to the target live preview. Accordingly, the method for processing the live preview may further include: querying live preview information that records status information corresponding to one or more published live previews, the status information representing whether a live streaming corresponding to the one or more published live previews has expired without being streamed.

Optionally, responding to the predetermined event for the target live preview includes: triggering, in response to found status information representing that a live streaming corresponding to a published live preview has expired without being streamed, the expired unbroadcast event.

In a particular embodiment, the target live preview is the published live preview of which the status information represents the live streaming corresponding to the published live preview has expired without being streamed.

In an optional embodiment, the data format of the live preview information may be a list. Optionally, the live preview information may include a preview identification of a published live preview, a preset start time for the published live preview, and status information. Specifically, the status information corresponding to each published live preview may be updated with information about the preset start time, the current time, and whether or not the live streaming starts.

In an optional embodiment, the live preview information can be queried at a predetermined frequency. Optionally, the predetermined frequency can be pre-set in conjunction with the actual application. Optionally, the server can query the live preview information for the status information by calling the reservation service. Accordingly, the expired unbroadcast event may be triggered in response to the found status information representing that the live streaming corresponding to the published live preview has expired without being streamed, and the reservation information of the target live preview may be obtained.

In the above embodiments, by querying the live preview information, the live streaming corresponding to the target live preview that has expired without being streamed can be found in time, and the expired unbroadcast event can be triggered quickly, thus improving the efficiency and effectiveness of the subsequent monitoring of live streaming previews.

In an optional embodiment, triggering, in response to found status information representing that the live streaming corresponding to the published live preview has expired without being streamed, the expired unbroadcast event, includes: storing the target live preview to a predetermined Massage Queue; and triggering, in response to the target live preview being monitored from the predetermined Message Queue based on a predetermined component, the expired unbroadcast event.

In an optional embodiment, the predetermined Message Queue may be a pre-set message queue for storing a published live preview corresponding to which a live streaming has expired without being streamed. In a particular embodiment, storing the target live preview to the predetermined Message Queue as described above may include storing a preview identification of the target live preview to the predetermined Message Queue.

In a particular embodiment, the predetermined component can be a consumer component corresponding to the predetermined Message Queue and can be used to monitor the target live preview in the predetermined Message Queue.

In the above embodiments, the target live preview corresponding to which the live streaming has expired without being streamed is stored into the preset message queue, and the target live preview is monitored from the predetermined Message Queue based on the predetermined component, which can effectively reduce the pressure on the system to deal with abnormal events and thus improve the stability of the system.

In an optional embodiment, the predetermined event includes the deletion preparation event for the target live preview, and accordingly, responding to the predetermined event for the target live preview may include: triggering, in response to a deletion request for the target live preview being received from a terminal corresponding to the target object, the deletion preparation event.

In a particular embodiment, the target object may be an anchor account corresponding to the target live preview, and the terminal corresponding to the target object may be a terminal with the anchor account logged in. Optionally, the user may trigger the deletion request at the terminal for the target live preview. Optionally, the server, upon receiving the deletion request, may call a predetermined deletion preparation interface, and the predetermined deletion preparation interface may be used to call the reservation service to obtain the reservation information. Optionally, the predetermined deletion preparation interface may be an application program interface for processing the deletion request.

In the above embodiments, the deletion preparation event is triggered when the deletion request for the target live preview is received from the terminal corresponding to the target object, which enables quick detection of predetermined event and thus improves the efficiency and effectiveness of the subsequent monitoring of live previews.

In an optional embodiment, the predetermined event includes the deletion confirmation event for the target live preview, and accordingly, responding to the predetermined event for the target live preview may include: triggering, in response to a deletion confirmation request for the target live preview being received from a terminal corresponding to the target object, the deletion confirmation event.

In a particular embodiment, the deletion confirmation request may be a request to confirm the deletion for the target live preview, and accordingly, in the case of receiving the deletion confirmation request for the target live preview from the terminal, the deletion confirmation event can be triggered, and then the target live preview can be deleted.

In an optional embodiment, the server may call a predetermined deletion confirmation interface upon receiving the deletion confirmation request, and the predetermined deletion confirmation interface may be used to call the reservation service to delete the target live preview. Optionally, the predetermined deletion confirmation interface may be an application program interface for processing the deletion confirmation request.

In the above embodiments, the deletion confirmation event is triggered in response receiving the deletion confirmation request for the target live preview from the terminal corresponding to the target object, which enables quick detection of predetermined event and thus improves the efficiency and effectiveness of the subsequent monitoring of live previews.

In step 203, in response to the reservation information meeting a predetermined condition, target processing information for the target live preview is sent to a target object based on the predetermined event.

In a particular embodiment, the predetermined condition may be a pre-set condition for processing the target object. Specifically, in the case where the reservation information indicates that the number of reservation viewers corresponding to the live streaming of the target live preview is non-zero (greater than or equal to zero), it can be determined that the reservation information meets the predetermined condition.

In a particular embodiment, the target processing information can be used to indicate processing information for the predetermined event.

In an optional embodiment, in response to the predetermined event including the deletion preparation event for the target live preview, sending target processing information for the target live preview to a target object based on the predetermined event, includes: generating a first prompt message based on the target processing information; and sending the first prompt message to the terminal, causing the terminal to display the first prompt message.

In an optional embodiment, the first prompt message may be used to prompt the processing that will be caused by deleting the target live preview. The specific processing can be configured in conjunction with the actual application, for example, it may be the live preview function is disabled for a predetermined number of days.

In an optional embodiment, the first prompt message, that is generated in combination with the target processing information and indicates the processing caused by deleting the target live preview, is sent to the terminal, which can timely remind the anchor that the processing will be triggered, and thus reduce the probability of triggering abnormal events, reduce the waste of system resources and improve the user experience.

In an optional embodiment, prior to sending the target processing information for the target live preview to the target object based on the predetermined event, the method for processing the live preview further includes: querying historical processing information corresponding to the target object; and generating, in response to the historical processing information being found, a second prompt message based on the historical processing information and the target processing information.

Accordingly, sending target processing information for the target live preview to a target object based on the predetermined event, may include: sending the second prompt message to the terminal, causing the terminal to display the second prompt message.

In a particular embodiment, the second prompt message can be used to prompt superimposed processing information corresponding to the historical processing information and the target processing information that is caused by deleting the target live preview. The historical processing information may be processing information triggered by a predetermined historical event. The historical processing information may be used to indicate processing information for a predetermined historical event. Specifically, the predetermined historical event may be an event that occurred prior to the above predetermined event that caused the live preview to be invalid. Specifically, the historical processing information may be processing information that is currently still in effect, i.e., has not yet been released.

In an optional embodiment, if the historical processing information is found, the superimposed processing information can be generated based on the processing information caused by the target live preview and the historical processing information, and the second prompt message corresponding to the superimposed processing information can be generated. If the historical processing information is not found, the above-mentioned first prompt message can be generated.

In a particular embodiment, assuming the historical processing information is that the live preview function is closed (blocked) for 3 days, and the processing information caused by the target live preview is that the live preview function is closed for 2 days, accordingly, the superimposed processing information can be that the live preview function is disabled for 5 days.

In the above embodiments, the processing can be more precise through the second prompt message of the superimposed processing information that is in combination with the historical processing information, which can timely remind the anchor that the processing will be triggered, thus reducing the probability of triggering abnormal events, reducing the waste of system resources and improving user experience.

In an optional embodiment, the method for processing the live preview may further include: storing the target processing information to a first storage device based on a preview identification of the target live preview; generating association information based on the preview identification of the target live preview and an object identification of the target object; and storing the association information to a second storage device.

In a particular embodiment, the first storage device and second storage device can be a database or a cache, which can be set in conjunction with the actual application. The first storage device can be used to store the processing information corresponding to one or more published live previews. The second storage device can be used to store the association information corresponding to one or more predetermined objects. Specifically, the predetermined object can be an object in the live streaming platform, and the one or more predetermined objects may include the target object. Optionally, the processing information corresponding to the published live preview and the association information can be stored in the same storage device.

In a particular embodiment, querying historical processing information corresponding to the target object, may include: querying association information corresponding to the target object from the second storage device based on the object identification of the target object; determining, based on the association information, a preview identification corresponding to a historical processed preview corresponding to the target object, where the historical processed preview is a live preview with processing information in one or more historical live previews of the target object; and querying, based on the preview identification corresponding to the historical processed preview, the historical processing information of the target object from the first storage device.

In an optional embodiment, the historical processing information may be stored in the first storage device. Optionally, the historical processing information may be stored in the first storage device together with the preview identification of the corresponding historical live preview. Optionally, while storing the historical processing information, the association information corresponding to the historical processing information may be stored in the second storage device. Specifically, the association information can be generated based on the object identification of the target object and the preview identification of the historical live preview. Specifically, the association information can be the object identification of the target object and the preview identification of the historical live preview in a one-to-one correspondence.

In the above embodiments, the combination of the stored association information that is generated based on the preview identification of the historical live preview and the object identification of the target object, and the processing information stored based on the preview identification of the published live preview, can facilitate the subsequent query of the processing information corresponding to the target object and improve the query efficiency and accuracy of the processing information.

In an optional embodiment, in the case where the reservation information indicates that the number of reservation viewers corresponding to the live streaming of the target live preview is zero, it may be determined that the reservation information does not meet the predetermined condition. Optionally, the method for processing the live preview may further include: sending, in response to the reservation information failing to meet the predetermined condition, a third prompt message to the terminal, causing the terminal to display the third prompt message.

In a particular embodiment, the third prompt message is used to prompt that no processing information is generated by deleting the target live preview.

In the above embodiments, in the case that the reservation information does not meet the predetermined condition, the third prompt message indicating that deleting the target live preview will not cause the processing is generated, which can accurately prompt the processing and improve the user experience.

In an optional embodiment, in the case where the predetermined event is the deletion confirmation event, if the reservation information does not meet the predetermined condition, the deletion operation of the target live preview may be performed directly.

In an optional embodiment, there is a time difference between the deletion request and the deletion confirmation request, and accordingly, there may be a case where the target object does not trigger processing after the deletion preparation event is triggered, but the target object triggers processing after the deletion confirmation event. Optionally, if the target object does not trigger processing after the deletion preparation event and the target object triggers processing after the deletion confirmation event, a predetermined processing prompt message may be sent to the terminal corresponding to the target object to prompt the target object that the deletion of the target live preview triggered the processing.

In an optional embodiment, in the case that the predetermined event is the expired unbroadcast event, if the reservation information does not meet the predetermined condition, the operation is not executed, and a prompt message of the expiration can also be fed back to the terminal.

In an optional embodiment, sending the target processing information for the target live preview to the target object based on the predetermined event, may include: sending, in response to a preview display request, the target processing information to a terminal corresponding to the target object, causing the terminal to display the target processing information on a preview creation page.

In an optional embodiment, the terminal corresponding to the target object may request the display of the live preview page through the preview creation interface at the service side. The preview creation interface may be an application program interface for processing events associated with the creation of the live preview. Optionally, the preview creation interface can be used to determine the presence of the preview identification of the processing information in combination with the object identification of the target object, and then can obtain the processing information corresponding to the target object in combination with the preview identification; and generate the processing detail information based on the processing information corresponding to the target object.

In a particular embodiment, the processing information corresponding to the target object may be all of the processing information currently in effect. Specifically, the processing information corresponding to the target object may include the target processing information. Accordingly, the above-mentioned sending the target processing information to the terminal corresponding to the target object may include: generating processing detail information based on the processing information corresponding to the target object; and sending the processing detail information to the terminal corresponding to the target object.

In a particular embodiment, the processing detail information may include the processing information triggered by the abnormal event (the creation of the preview being closed), a processing countdown, and a reason for abnormality. Optionally, the reason for abnormality may include information about the abnormal event, the time of the abnormal event, and the corresponding number of reserved viewers.

In the above embodiments, in the case of the target object requesting the display of the live preview page, the processing detail information is displayed on the preview creation page, which allows the user to clearly understand the reasons for the processing, avoids the triggering of abnormal events next time, better promotes the user to perform the live streaming according to the agreement, and enhances the rationality and effectiveness of the processing of live preview.

As seen from the above technical solution provided by the embodiments of this specification, in the case of the predetermined event triggered for the target live preview, combined with the reservation information of the target live preview, the target processing information is sent for the target live preview to the target object based on the predetermined event in response to the reservation information meeting a predetermined condition, which can achieve effective monitoring and processing of the live preview, help users understand the processing information intuitively and clearly, improve the rationality and effectiveness of processing the live preview, promote user to perform the live streaming according to the agreement, and thus reduce the probability of triggering abnormal events, reduce the waste of system resources and improve user experience.

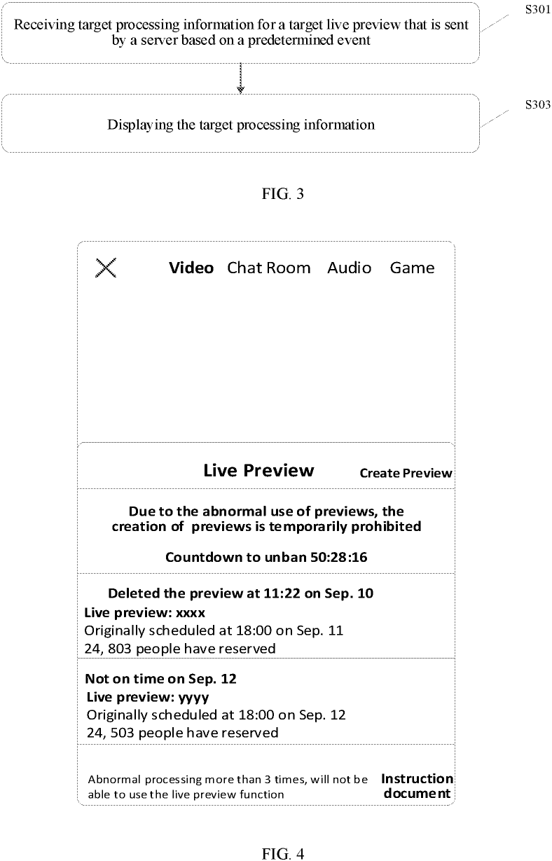

FIG. 3 is a flowchart of a method for processing a live preview illustrated according to an exemplary embodiment. As shown in FIG. 3, the method for processing the live preview is applied to a terminal, which includes the following steps S301 and S303.

In step S301, target processing information for a target live preview that is sent by a server based on a predetermined event is received.

In step S303, the target processing information is displayed.

In an optional embodiment, the terminal corresponds to a target object that includes a creator of a target live preview. For example, the target object may be an anchor account corresponding to the target live preview, and the terminal corresponding to the target object may be a terminal with the anchor account logged in.

In an optional embodiment, the predetermined event includes an event that causes the target live preview to be invalid. The target processing information is sent in response to reservation information of the target live preview meeting a predetermined condition and is configured at least for prompting a restriction on the use of the target live preview by the target object.

In an optional embodiment, the method for processing the live preview further includes: sending the server a preview display request; receiving the target processing information sent by the server in response to the preview display request; and displaying the target processing information on a preview creation page.

In a particular embodiment, a schematic diagram of a preview creation page is provided according to an exemplary embodiment, as shown in FIG. 4.

In the above embodiments, in the case of the target object requesting the display of the live preview page, the processing detail information is displayed on the preview creation page, which allows the user to clearly understand the reason for processing, avoid triggering an abnormal event next time, better promote user to perform the live streaming according to the agreement, and improve the rationality and effectiveness of the processing of the live preview.

In an optional embodiment, the predetermined event includes a deletion preparation event for the target live preview, and the method further includes: sending a deletion request for the target live preview to the server for triggering the deletion preparation event.

In the above embodiments, by sending the deletion request of the target live preview to the server, the deletion preparation event is triggered, the fast detection of the predetermined event can be realized, which in turn enhances the efficiency and effectiveness of the subsequent abnormal monitoring of the live previews.

In an optional embodiment, receiving target processing information for a predetermined event from a server, includes: receiving from the server a first prompt message generated based on the target processing information, where the first prompt message is used to prompt processing caused by deleting the target live preview.

In the above embodiments, the first prompt message, that is generated in combination with the target processing information and indicates the processing caused by deleting the target live preview, can timely remind the anchor that the processing will be triggered, thus reducing the probability of triggering abnormal events, reducing system waste of system resources and improving user experience.

In an optional embodiment, receiving target processing information for a predetermined event from a server, includes: receiving from the server a second prompt message generated based on historical processing information corresponding to a target object and the target processing information, where the second prompt message is used to prompt superimposed processing information corresponding to the historical processing information and processing information that is caused by deleting the target live preview.

In an optional embodiment, the historical processing information includes processing information indicating a historical event that caused a live preview to be invalid.

In the above embodiments, the processing can be more precisely through the second prompt message of the superimposed processing information that is in combination with the historical processing information, which can timely remind the anchor that the processing will be triggered, thus reducing the probability of triggering abnormal events, reducing the waste of system resources and improving user experience.

In an optional embodiment, the method for processing the live preview further includes: receiving a third prompt message from the server, where the third prompt message is sent in response to the reservation information failing to meet the predetermined condition, and is used to prompt that no processing information is generated by deleting the target live preview.

In the above embodiments, in the case that the reservation information does not meet the predetermined condition, the third prompt message indicating that deleting the target live preview will not cause the processing is generated, which can accurately prompt the processing and improve the user experience.

In a particular embodiment, the first, second and third prompt messages above can be displayed on a preview deletion page via pop-ups, etc.

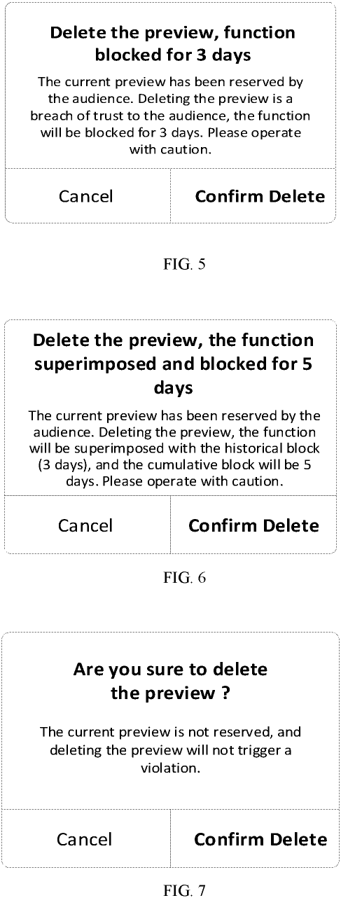

In a particular embodiment, taking the first prompt message as an example, FIG. 5 is a schematic diagram of the first prompt message provided according to an exemplary embodiment. Optionally, the user can click on the cancel control (“Cancel”) to cancel the deletion of the target live preview, or click on the confirm control (“Confirm Delete”) to trigger the deletion confirmation request.

In a particular embodiment, taking the second prompt message as an example, FIG. 6 is a schematic diagram of the second prompt message provided according to an exemplary embodiment. Optionally, the user can click on the cancel control (“Cancel”) to cancel the deletion of the target live preview, or click on the confirm control (“Confirm Delete”) to trigger the deletion confirmation request.

In a particular embodiment, taking the third prompt message as an example, FIG. 7 is a schematic diagram of the third prompt message provided according to an exemplary embodiment. Optionally, the user can click on the cancel control (“Cancel”) to cancel the deletion of the target live preview, or click on the confirm control (“Confirm Delete”) to trigger the deletion confirmation request.

In an optional embodiment, the predetermined event includes a deletion confirmation event for the target live preview, and the method for processing the live preview further includes: sending a deletion confirmation request for the target live preview to the server for triggering the deletion confirmation event.

In the above embodiments, the deletion confirmation event is triggered in response sending the deletion confirmation request for the target live preview to the server, which enables quick detection of predetermined event and thus improves the efficiency and effectiveness of the subsequent monitoring of live previews.

In an optional embodiment, the predetermined event includes an expired unbroadcast event of a live streaming corresponding to the target live preview, and the expired unbroadcast event is triggered in response to status information being found in the live preview information, the found status information corresponding to the target live preview and representing that the live streaming corresponding to the target live preview has expired without being streamed; where the live preview information records status information corresponding to one or more published live previews, the status information represents whether a live streaming corresponding to the one or more published live previews has expired without being streamed, and the one or more published previews include the target live preview.

In the above embodiments, by querying the live preview information, the live streaming corresponding to the target live preview that has expired without being streamed can be found in time, and the expired unbroadcast event can be triggered quickly, thus improving the efficiency and effectiveness of the subsequent monitoring of live streaming previews.

The specific manner of each step in the foregoing terminal-side embodiments has been described in detail in the server-side embodiments related to the method, and will not be described in detail here.

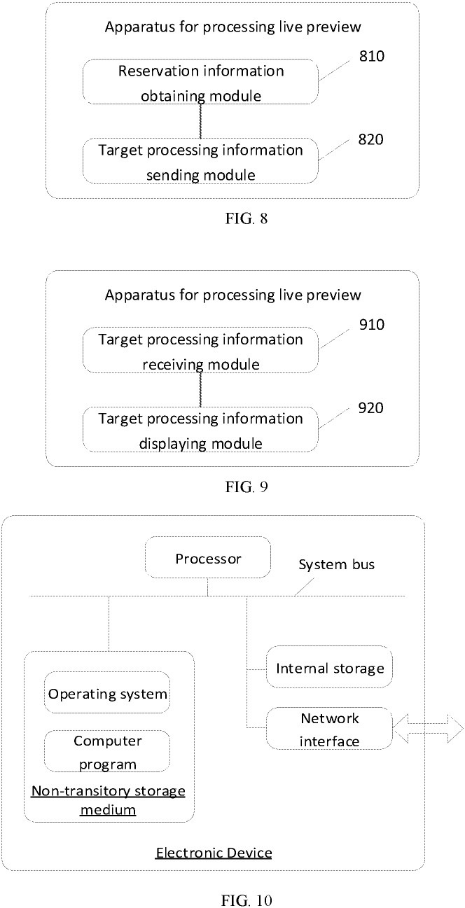

FIG. 8 is a block diagram of an apparatus for processing a live preview illustrated according to an exemplary embodiment. As shown in FIG. 8, the apparatus includes the following modules.

A reservation information obtaining module 810 is configured to obtain, in response to a predetermined event for a target live preview, reservation information for the target live preview, the predetermined event including an event that causes the target live preview to be invalid.

A target processing information sending module 820 is configured to send, in response to the reservation information meeting a predetermined condition, target processing information for the target live preview to a target object based on the predetermined event, the target object including a creator of the target live preview, the target processing information being configured at least for prompting a restriction on the use of the target live preview by the target object.

Optionally, the target processing information sending module 820 includes a target processing information sending unit configured to send, in response to a preview display request, the target processing information to a terminal corresponding to the target object, causing the terminal to display the target processing information on a preview creation page.

Optionally, the predetermined event includes a deletion preparation event for the target live preview, and the reservation information obtaining module 810 include a deletion preparation event trigger unit configured to trigger, in response to a deletion request for the target live preview being received from a terminal corresponding to the target object, the deletion preparation event.

Optionally, the target processing information sending module 820 includes a first prompt message generation unit configured to generate a first prompt message based on the target processing information, where the first prompt message prompts processing caused by deleting the target live preview; and a first prompt message sending unit configured to send the first prompt message to the terminal, causing the terminal to display the first prompt message.

Optionally, the apparatus further includes: a historical processing information query module configured to query historical processing information corresponding to the target object prior to sending target processing information for the target live preview to a target object based on the predetermined event, where the historical processing information includes processing information indicating a historical event that caused a live preview to be invalid; and a second prompt message generation unit configured to generate, in response to the historical processing information being found, a second prompt message based on the historical processing information and the target processing information, where the second prompt message prompts superimposed processing information corresponding to the historical processing information and processing information that is caused by deleting the target live preview. The target processing information sending module 820 include a second prompt message sending unit configured to send the second prompt message to the terminal, causing the terminal to display the second prompt message.

Optionally, the apparatus further includes: a target processing information storage module configured to store the target processing information to a first storage device based on a preview identification of the target live preview, where the first storage device stores processing information corresponding to one or more published live previews; an association information generation module configured to generate association information based on the preview identification of the target live preview and an object identification of the target object; and an association information storage module configured to store the association information to a second storage device, where the second storage device stores association information of one or more predetermined objects, and the one or more predetermined objects comprise the target object. The historical processing information query module includes: an association information query unit configured to query association information corresponding to the target object from the second storage device based on the object identification of the target object; a preview identification determination unit configured to determine, based on the association information, a preview identification corresponding to a historical processed preview corresponding to the target object, where the historical processed preview is a live preview with processing information in one or more historical live previews of the target object; and a historical processing information query unit configured to query, based on the preview identification corresponding to the historical processed preview, the historical processing information of the target object from the first storage device.

Optionally, the apparatus further includes a third prompt message sending module configured to send, in response to the reservation information failing to meet the predetermined condition, a third prompt message to the terminal, causing the terminal to display the third prompt message, where the third prompt message prompts that no processing information is generated by deleting the target live preview.

Optionally, the predetermined event includes an expired unbroadcast event of a live streaming corresponding to the target live preview, and the apparatus further includes: a live preview information query module configured to query live preview information that records status information corresponding to one or more published live previews, the status information representing whether a live streaming corresponding to the one or more published live previews has expired without being streamed. The reservation information obtaining module 810 includes an expired unbroadcast event trigger unit configured to trigger, in response to found status information representing that the live streaming corresponding to the target live preview has expired without being streamed, the expired unbroadcast event.

Optionally, the expired unbroadcast event trigger unit includes a target live preview storage unit configured to store, in response to found status information representing that the live streaming corresponding to the target live preview has expired without being streamed, the target live preview to a predetermined Massage Queue. The expired unbroadcast event trigger unit is further configured to trigger, in response to the target live preview being monitored from the predetermined Message Queue, the expired unbroadcast event.

Optionally, the predetermined event includes a deletion confirmation event for the target live preview, and the reservation information obtaining module 810 includes a deletion confirmation event trigger unit configured to trigger, in response to a deletion confirmation request for the target live preview being received from a terminal corresponding to the target object, the deletion confirmation event.

FIG. 9 is a block diagram of an apparatus for processing a live preview illustrated according to an exemplary embodiment. As shown in FIG. 9, the apparatus includes the following modules.

A target processing information receiving module 910 is configured to receive target processing information for a target live preview that is sent by a server based on a predetermined event, where the predetermined event includes an event that causes the target live preview to be invalid, and the target processing information is sent in response to reservation information of the target live preview meeting a predetermined condition and is configured at least for prompting a restriction on the use of the target live preview by the target object.

A target processing information displaying module 920 is configured to display the target processing information.

Optionally, the target processing information receiving module includes: a display request sending unit configured to send the server a preview display request; and a target processing information receiving unit configured to receive the target processing information from the server in response to the preview display request. The target processing information displaying module 920 is further configured to display the target processing information on a preview creation page.

Optionally, the predetermined event includes a deletion preparation event for the target live preview, and the apparatus further includes a deletion request sending module configured to send a deletion request for the target live preview to the server for triggering the deletion preparation event.

Optionally, the target processing information receiving unit is further configured to receive from the server a first prompt message generated based on the target processing information, where the first prompt message prompts processing caused by deleting the target live preview.

Optionally, the target processing information receiving unit is further configured to receive from the server a second prompt message generated based on historical processing information corresponding to a target object and the target processing information, where the historical processing information includes processing information indicating a historical event that caused a live preview to be invalid, and the second prompt message prompts superimposed processing information corresponding to the historical processing information and processing information that is caused by deleting the target live preview.

Optionally, the apparatus further includes a third prompt message receiving module configured to receive a third prompt message from the server, where the third prompt message is sent in response to the reservation information failing to meet the predetermined condition, and prompts that no processing information is generated by deleting the target live preview.

Optionally, the predetermined event includes a deletion confirmation event for the target live preview, and the apparatus further includes a deletion confirmation request sending module configured to send a deletion confirmation request for the target live preview to the server for triggering the deletion confirmation event.

Optionally, the predetermined event includes an expired unbroadcast event of a live streaming corresponding to the target live preview, and the expired unbroadcast event is triggered in response to status information being found in the live preview information, the found status information corresponding to the target live preview and representing that the live streaming corresponding to the target live preview has expired without being streamed; where the live preview information records status information corresponding to one or more published live previews, the status information represents whether a live streaming corresponding to the one or more published live previews has expired without being streamed, and the one or more published previews include the target live preview.

With respect to the apparatus in the above embodiments, the specific manner in which each module performs its operation has been described in detail in the embodiments of the method, and will not be described in detail here.

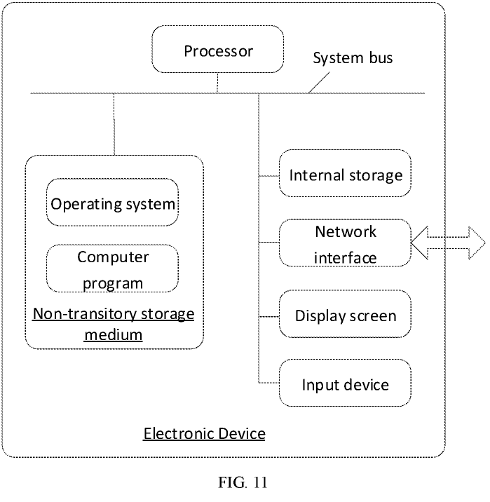

FIG. 10 is a block diagram of an electronic device for processing a live preview illustrated according to an exemplary embodiment. The electronic device can be a server, and its internal structure can be illustrated in FIG. 10. The electronic device includes a processor connected via a system bus, a memory, and a network interface. The processor of the electronic device is used to provide computing and control capabilities. The memory of the electronic device includes a non-transitory storage medium, and an internal memory. The non-transitory storage medium stores an operating system and a computer program. The internal memory provides an environment for operation of the operating system and the computer program in the non-transitory storage medium. The network interface of the electronic device is used to communicate with an external terminal via a network connection. The computer program is executed by the processor in order to implement a method for processing a live preview.

FIG. 11 is a block diagram of an electronic device for processing a live preview illustrated according to an exemplary embodiment. The electronic device may be a terminal and its internal structure may be illustrated in FIG. 11. The electronic device includes a processor, a memory, a network interface, a display and an input device that are connected via a system bus. The processor of the electronic device is used to provide computing and control capabilities. The memory of the electronic device includes a non-transitory storage medium and an internal memory. The non-transitory storage medium stores an operating system and a computer program. The internal memory provides an environment for operation of the operating system and the computer program in the non-transitory storage medium. The electronic device has a network interface for communicating with an external terminal via a network connection. The computer program is executed by the processor in order to implement a method for processing a live preview. The display of the electronic device can be a liquid crystal display or electronic ink display. The input device of the electronic device can be a touch layer overlay on the display, or keys, trackball or touchpad set on the housing of the electronic device, or external keyboard, touchpad or mouse, etc.

It should be understood by those skilled in the art that the structures illustrated in FIG. 10 or FIG. 11 are merely block diagrams of portions of the structures associated with the solutions of the present disclosure and do not constitute a limitation of the electronic device to which the solutions of the present disclosure apply. Specific electronic devices may include more or fewer components than shown in the figures, or a combination of certain components, or have a different arrangement of components.

In exemplary embodiments, there is also provided an electronic device including a processor and a memory storing instructions executable by the processor. The processor is configured to execute the instructions to implement the method for processing the live preview as described in embodiments of the present disclosure.

In exemplary embodiments, there is also provided a non-transitory computer-readable storage medium that, when instructions in the storage medium are executed by a processor of the electronic device, enables the electronic device to perform the method for processing the live preview as described in embodiments of the present disclosure.

In the exemplary embodiment, there is also provided a computer program product including instructions that, when run on a computer, cause the computer to perform the method for processing the live preview as described in embodiments of the present disclosure.

One of ordinary skill in the art can understand that implementing all or part of the processes in the methods of the above embodiments is accomplished by directing the associated hardware by means of a computer program, which may be stored in a non-transitory computer readable storage medium. The computer program, when executed, may include processes such as those of the embodiments of the methods described above. Any reference to memory, storage, database, or other media used in the embodiments provided in this application may include non-transitory and/or transitory memory. The non-transitory memory may include read-only memory (ROM), programmable ROM (PROM), electrically programmable ROM (EPROM), electrically erasable programmable ROM (EEPROM), or flash memory. The transitory memory may include random access memory (RAM) or external cache memory. By way of illustration and not limitation, RAM is available in a variety of forms, such as static RAM (SRAM), dynamic RAM (DRAM), synchronous DRAM (SDRAM), double data rate SDRAM (DDRSDRAM), enhanced SDRAM (ESDRAM), synchronous link DRAM (SLDRAM), memory bus (Rambus) direct RAM (RDRAM), direct memory bus dynamic RAM (DRDRAM), and memory bus dynamic RAM (RDRAM), etc.

Other embodiments of the present disclosure will readily occur to those skilled in the art upon consideration of the specification and practice of the invention disclosed herein. This application is intended to cover any variation, use, or adaptation of the present disclosure that follows the general principles of the present disclosure and includes commonly known or customary technical means in the art that are not disclosed herein. The description and embodiments are considered exemplary only, and the true scope and spirit of the disclosure is indicated by the following claims.

It should be understood that the present disclosure is not limited to the precise construction already described above and illustrated in the accompanying drawings, and that various modifications and changes may be made without departing from its scope. The scope of the present disclosure is limited only by the appended claims.

What is claimed is:

1. A method for processing a live preview, applied to a server, comprising:
obtaining, in response to a predetermined event for a target live preview, reservation information for the target live preview, the predetermined event comprising an event that causes the target live preview to be invalid; and
sending target processing information, in response to the reservation information meeting a predetermined condition, for the target live preview to a target object based on the predetermined event, the target object comprising a creator of the target live preview, the target processing information being configured at least for prompting a restriction on the use of the target live preview by the target object.

2. The method of claim 1, wherein the sending target processing information for the target live preview to a target object based on the predetermined event, comprises:
sending, in response to a preview display request, the target processing information to a terminal corresponding to the target object, causing the terminal to display the target processing information on a preview creation page.

3. The method of claim 1, wherein the predetermined event comprises a deletion preparation event for the target live preview, and the deletion preparation event is triggered in response to a deletion request for the target live preview being received from a terminal corresponding to the target object.

4. The method of claim 3, wherein the sending target processing information for the target live preview to a target object based on the predetermined event, comprises:
generating a first prompt message based on the target processing information, wherein the first prompt message prompts processing caused by deleting the target live preview; and
sending the first prompt message to the terminal, causing the terminal to display the first prompt message.

5. The method of claim 3, further comprising:
querying historical processing information corresponding to the target object, wherein the historical processing information comprises processing information indicating a historical event that caused a live preview to be invalid; and
generating, in response to the historical processing information being found, a second prompt message based on the historical processing information and the target processing information, wherein the second prompt message prompts superimposed processing information corresponding to the historical processing information and processing information that is caused by deleting the target live preview; and
wherein the sending target processing information for the target live preview to a target object based on the predetermined event, comprises:
sending the second prompt message to the terminal, causing the terminal to display the second prompt message.

6. The method of claim 5, further comprising:
storing the target processing information to a first storage device based on a preview identification of the target live preview, wherein the first storage device stores processing information corresponding to one or more published live previews;
generating association information based on the preview identification of the target live preview and an object identification of the target object; and
storing the association information to a second storage device, wherein the second storage device stores association information of one or more predetermined objects, and the one or more predetermined objects comprise the target object;
wherein the querying historical processing information corresponding to the target object, comprises:
querying association information corresponding to the target object from the second storage device based on the object identification of the target object;
determining, based on the association information, a preview identification corresponding to a historical processed preview corresponding to the target object, wherein the historical processed preview is a live preview with processing information in one or more historical live previews of the target object; and
querying, based on the preview identification corresponding to the historical processed preview, the historical processing information of the target object from the first storage device.

7. The method of claim 3, further comprising:
sending, in response to the reservation information failing to meet the predetermined condition, a third prompt message to the terminal, causing the terminal to display the third prompt message, wherein the third prompt message prompts that no processing information is generated by deleting the target live preview.

8. The method of claim 1, wherein the predetermined event comprises an expired unbroadcast event of a live streaming corresponding to the target live preview, and the method further comprises:
querying live preview information that records status information corresponding to one or more published live previews, the status information representing whether a live streaming corresponding to the one or more published live previews has expired without being streamed; and
triggering, in response to found status information representing that the live streaming corresponding to the target live preview has expired without being streamed, the expired unbroadcast event.

9. The method of claim 8, wherein the triggering, in response to found status information representing that the live streaming corresponding to the target live preview has expired without being streamed, the expired unbroadcast event, comprises:
storing the target live preview to a predetermined Massage Queue; and
triggering, in response to the target live preview being monitored from the predetermined Message Queue, the expired unbroadcast event.

10. The method of claim 1, wherein the predetermined event comprises a deletion confirmation event for the target live preview, and the deletion confirmation event is triggered in response to a deletion confirmation request for the target live preview being received from a terminal corresponding to the target object.

11. A method for processing a live preview, applied to a terminal corresponding to a target object that comprises a creator of a target live preview, the method comprising:
receiving target processing information for the target live preview that is sent by a server based on a predetermined event, wherein the predetermined event comprises an event that causes the target live preview to be invalid, and the target processing information is sent in response to reservation information of the target live preview meeting a predetermined condition and is configured at least for prompting a restriction on the use of the target live preview by the target object; and
displaying the target processing information.

12. The method of claim 11, further comprising:
sending the server a preview display request;
receiving the target processing information sent by the server in response to the preview display request; and
displaying the target processing information on a preview creation page.

13. The method of claim 11, wherein the predetermined event comprises a deletion preparation event for the target live preview, and the method further comprises:
sending a deletion request for the target live preview to the server for triggering the deletion preparation event.

14. The method of claim 13, wherein the receiving target processing information for the target live preview from a server, comprises:
receiving from the server a first prompt message generated based on the target processing information, wherein the first prompt message prompts processing caused by deleting the target live preview.

15. The method of claim 13, wherein the receiving target processing information for the target live preview from a server, comprises:
receiving from the server a second prompt message generated based on historical processing information corresponding to the target object and the target processing information, wherein the historical processing information comprises processing information indicating a historical event that caused a live preview to be invalid, and the second prompt message prompts superimposed processing information corresponding to the historical processing information and processing information that is caused by deleting the target live preview.

16. The method of claim 13, further comprising:
receiving a third prompt message from the server, wherein the third prompt message is sent in response to the reservation information failing to meet the predetermined condition, and prompts that no processing information is generated by deleting the target live preview.

17. The method of claim 11, wherein the predetermined event comprises a deletion confirmation event for the target live preview, and the method further comprises:
sending a deletion confirmation request for the target live preview to the server for triggering the deletion confirmation event.

18. The method of claim 11, wherein
the predetermined event comprises an expired unbroadcast event of a live streaming corresponding to the target live preview;
the expired unbroadcast event is triggered in response to status information being found in live preview information, the found status information corresponding to the target live preview and representing that the live streaming corresponding to the target live preview has expired without being streamed; and
the live preview information records status information corresponding to one or more published live previews, the status information representing whether a live streaming corresponding to the one or more published live previews has expired without being streamed, and the one or more published previews comprising the target live preview.

19. An electronic device, comprising:
a processor; and
a memory for storing instructions executable by the processor;
wherein the processor is configured to execute the instructions to:
obtain, in response to a predetermined event for a target live preview, reservation information for the target live preview, the predetermined event comprising an event that cause the target live preview to be invalid; and
send, in response to the reservation information meeting a predetermined condition, target processing information for the target live preview based on the predetermined event to a target object, the target object comprising a creator of the target live preview, the target processing information being configured at least for prompting a restriction on the use of the target live preview by the target object.

20. An electronic device, comprising:
a processor; and
a memory for storing instructions executable by the processor;
wherein the processor is configured to execute the instructions to implement the method for processing the live preview of claim 11.
